(19) United States
(12) Patent Application Publication
(10) Pub. No.: US 2008/0157911 A1
(43) Pub. Date: Jul. 3, 2008

(54) Soft magnetic layer for on-die inductively coupled wires with high electrical resistance

(76) Inventors: Arnel M. Fajardo, Beaverton, OR (US); Chang-Min Park, Portland, OR (US); Marc. C. French, Forest Grove, OR (US); Ebrahim Andideh, Portland, OR (US)

Correspondence Address: INTEL/BLAKELY, 1279 OAKMEAD PARKWAY, SUNNYVALE, CA, 94085-4040, US

(21) Appl. No.: 11/647,955

(22) Filed: Dec. 29, 2006

(51) Int. Cl. H01F 19/00

(52) U.S. Cl. 336/175; 29/602.1

(57) ABSTRACT

On-die inductively coupled wires and a method of making on-die inductively coupled wires are described. The on-die inductively coupled wires include a first wire to carry a first current, a surface area bounded by a second wire, and, a layer to couple magnetic flux induced by said the first current through the surface area. The layer comprises regions of dielectric material and regions of soft magnetic material.

### FIELD OF INVENTION

The field of invention relates generally to on-die inductively coupled wires, and, more specifically, to on-die inductively coupled wires having improved electrical power consumption efficiency through reduced eddy currents.

### BACKGROUND

FIG. 1 shows a pair of magnetically coupled or “inductively coupled” wires 130. Inductively coupled wires couple magnetic flux, generated by a time varying signal that flows through a primary wire, through the cross section of a surface area bounded by the winding of a secondary wire. Inductively coupled wires may be used to form various electrical components such as an inductor or a transformer.

Referring to FIG. 1, wire 109 corresponds to the primary wire and wire 110 corresponds to the secondary wire 110. A time varying signal Ip flows through the primary wire and generates a circular magnetic field H according to Ampere's law (Δ×H=Jp where Jp is the current density of the primary signal Ip). A magnetic core 104 that surrounds both the primary and secondary wires 109, 110 essentially converts the magnetic field H generated by the time-varying primary signal Ip into a strong magnetic flux density β that circulates around the magnetic core 104 and flows through the cross section of a surface area A bounded by the secondary wire 110. A secondary time-varying signal Is is generated in the secondary wire 110 owing to Faraday's law (Δ×E=−δΦ/δt where δΦ/δt is the time rate of change of the magnetic flux that flows through cross section A and E is the electric field induced in the secondary wire 110 that causes the secondary signal Is to flow).

In order to create a strong “coupling” between the induced signal Is and the primary signal Ip, the magnetic properties of the magnetic core 104 should be sufficiently “soft”. Referring to the hysteresis loop 140 of FIG. 1, soft magnetic materials are understood to exhibit high saturation magnetic flux density B_{SAT} and low coercivity Hc. As the magnetic field H generated by the primary signal Ip extends beyond the coercivity of the magnetic core (which may occur even at weak primary signal Ip strengths owing to the low coercivity Hc of the magnetic core) the magnetic flux density B that circulates around the magnetic core rapidly increases in response (owing to the high B_{SAT} of the magnetic core). As a consequence a significant amount of magnetic flux flows through cross section A.

The strength of the magnetic field strength H may be made to increase for a given primary signal by looping the primary wire around the magnetic core a number of times. Similarly, the magnitude of the response signal Is may be made to increase by looping the secondary wire a number of times around the magnetic core 104. The magnetic properties of the core 104 and the number of windings associated with the primary and/or secondary signals may be specially designed so that the inductively coupled wires can be used as a transformer where the amplitudes of the primary and secondary signals have a specific designed for ratio. In the case of a 1:1 primary:secondary winding ratio (i.e., each wire runs once through the core) the inductively coupled wires effectively form an inductor in which a voltage V appears across the secondary wire as a function of K(δIp/δt).

A problem with inductively coupled wires is the generation of eddy currents within the magnetic core. Here, the phenomena described by Faraday's law induces electrical currents to flow within the magnetic core 104. These currents cause the magnetic core to consume electrical power owing to the electrical power consumption relationship P=I²R where P is the electrical power consumed by the magnetic core, I is the magnitude of an eddy current that flows through the magnetic core and R is the electrical resistance of the magnetic core through which the eddy current flows. The power consumption of the magnetic core can be reduced by increasing the inherent resistivity of the magnetic core 104. Here, a higher resistivity will result in less eddy current in the magnetic core. This, in turn, drops the overall power consumption of the core because power consumption is a function of the square of the eddy current flow.

### BRIEF DESCRIPTION OF THE DRAWING

The present invention is illustrated by way of example and not limitation in the figures of the accompanying drawings, in which like references indicate similar elements and in which:

FIG. 1 shows inductively coupled wires;

FIG. 2 shows on-die inductively coupled wires;

FIGS. 3A through 3H together show a manufacturing process for constructing on-die inductively coupled wires;

FIGS. 4a through 4d show a laminated-like soft magnetic layer formed with alternating layers of soft magnetic material and an ion implanted surface of soft magnetic material;

FIG. 5 shows a composite soft magnetic layer formed with soft magnetic nanocomposites embedded in a dielectric;

FIG. 6 shows a composite soft magnetic layer formed with a porous dielectric having soft magnetic material within its porous regions;

FIG. 7 shows a computing system.

### DETAILED DESCRIPTION

In the manufacture of electronic systems, there exists economic efficiency in integrating as many electronically interconnected components as possible with a single manufacturing process. This often results in a motivation to combine as many electronic components as possible onto a single “die” of processed semiconductor material. Moreover, it is not uncommon for a packaged semiconductor chip to be designed to use a voltage regulator that that is located external to the semiconductor chip package on the same “planar” or “PC board” that the semiconductor chip package is mounted to. The voltage regulator essentially suppresses variations in a power supply voltage that is ideally a constant, DC voltage. As is well known in the art, voltage regulators may be built with an “LC” filter where L corresponds to an inductor that physically resides external to the semiconductor chip package.

With the need for a voltage regulator and the need to integrate as many electronic components onto a semiconductor die as is possible, a motivation exists to build “on-die” voltage regulators. That is, a motivation exists to construct a voltage regulator into the various layering of conductive and dielectric materials that are processed onto a semiconductor wafer, which is subsequently cut into a “die” and packaged.

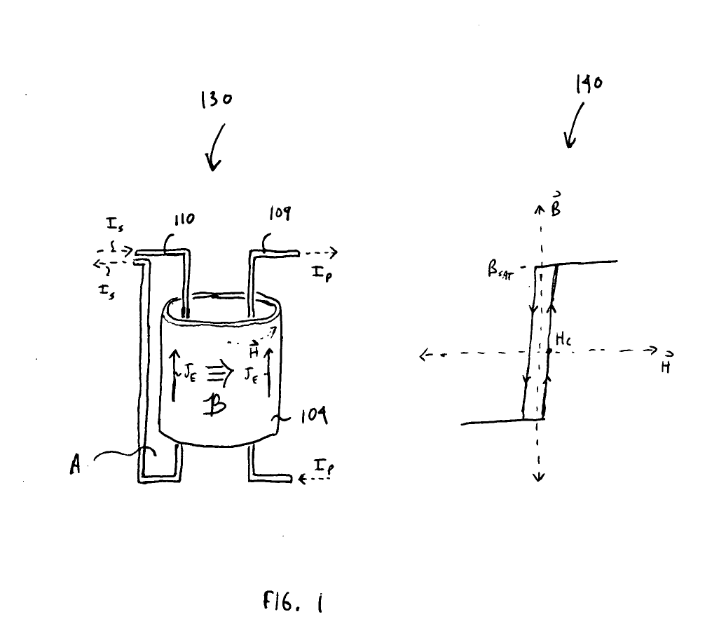

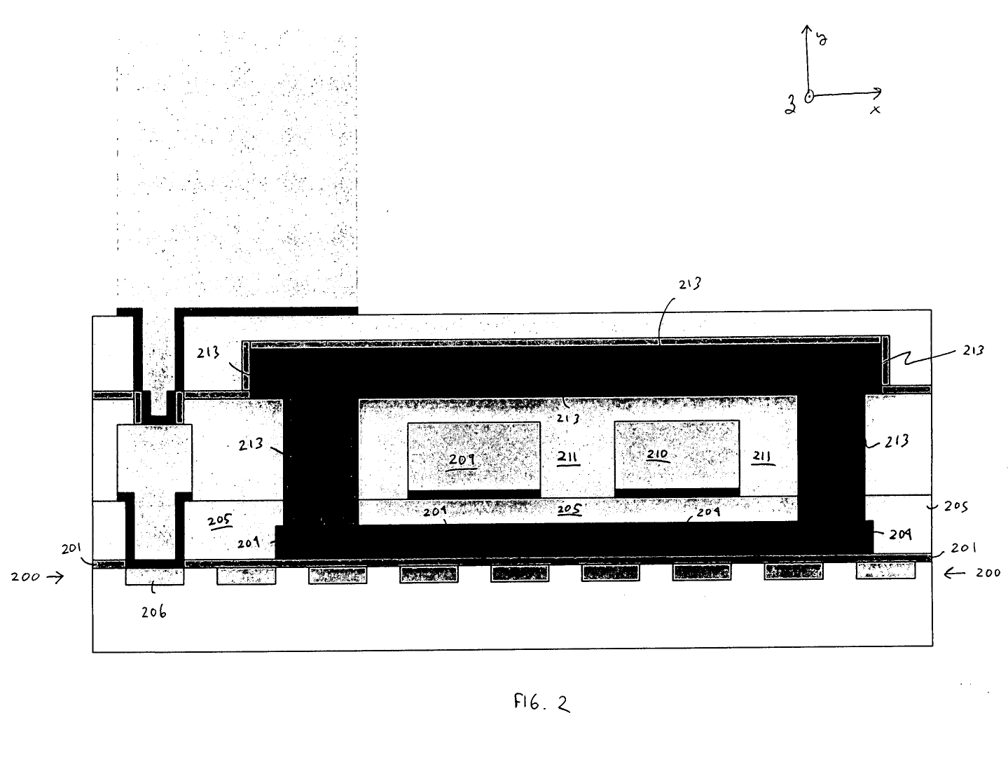

By eliminating the need for an external voltage regulator, printed circuit board space is conserved which should lower the manufacturing costs of the printed circuit board end-product. FIG. 2 shows “on-die” inductively coupled wires whose design is similar to the inductively coupled wires depicted in FIG. 1. In an implementation, the inductively coupled wires are used as an inductor within an LC circuit that is used by a voltage regulator circuit that is also manufactured “on-die”.

According to the on-die inductively coupled wiring design of FIG. 2, the highest layer of transistor-to-transistor interconnect wiring in represented as layer 200. Here, feature 206 corresponds to the cross-section of one “highest level transistor interconnect” wire. The inductively coupled wires are constructed over the highest layer interconnect wire 200. A dielectric nitride layer 201 insulates the highest level interconnect wiring 200 from the inductively coupled wiring structure. The inductively coupled wiring structure is essentially constructed from a lower magnetic layer 204 and a higher magnetic layer 213 that are connected so as to surround primary wiring 209 and secondary wiring 210 with magnetic material similar to the manner in which the primary and secondary wires 109, 110 of FIG. 1 are surrounded by soft magnetic material 104. The primary and secondary wires 209, 210 are electrically isolated from the surrounding magnetic material 204, 213 by the presence of a lower dielectric layer 205 and a higher dielectric layer 211.

In order to reduce the detrimental effects of eddy currents, the magnetic core material constructed from magnetic layers 204, 213 should exhibit sufficiently high electrical resistance while maintaining sufficiently “soft” magnetic properties. As described in the background, high electrical resistance suppresses the flow of any induced eddy currents. That is, the overall magnitude of induced electrical current flow from eddy currents will be lower in a magnetic core material having higher electrical resistance than an otherwise identical magnetic core material having lower electrical resistance. Because the magnitude of the induced eddy currents is lower, the energy loss (or power consumption) of the inductively coupled wires will be reduced resulting in a more electrically efficient device. Also, for the reasons discussed above in the background with respect to the hysteresis loop of FIG. 1, the magnetic core material should still be sufficiently soft. That is, provide a sufficiently high magnetic flux density while exhibiting a sufficiently low coercivity. In so doing, the inductively coupled wires will exhibit efficient magnetic flux linkage between the primary wiring and the secondary wiring.

The following dimensions as depicted in FIG. 2 may apply (all ranges being inclusive): 1) primary wire 209 length=500-1000 μm; 2) primary wire 209 width=10-50 μm; 3) secondary wire 210 width=10-50 μm; 4) secondary wire 210 length=500-1000 μm; 5) lower dielectric layer 205 thickness=1-20 μm; 6) higher dielectric layer 211 thickness 220=5-20 μm; 7) lower magnetic layer 204 thickness=0.1-5 μm; 8) lower magnetic layer 204 width=100-200 μm; 9) lower magnetic layer 204 length=500-1000 μm; 10) higher magnetic layer 213 thickness=5-30 μm; 11) higher magnetic layer 213 width=0.1-5 μm; and, 12) higher magnetic layer 213 length=100-200 μm. Here, width is measured horizontally along the x axis of FIG. 2, thickness is measured vertically along the y axis FIG. 2 and length is measured “in-and-out” along the z axis FIG. 2.

According to this design, sufficiently soft magnetic properties for both the lower and higher magnetic layers 204, 213 corresponds to a saturation magnetic flux density (β_{SAT}) of greater than 1.0 Tesla (T) and a magnetic coercivity (Hc) of less than 10.0 Oersteads (Oe)). Moreover, in order to sufficiently suppress the magnitude of induced eddy currents, both the lower and higher magnetic layers 204, 213 are also designed to have resistivities higher than 140 ρΩ·cm and preferably at least as high as 400 μΩ·cm. Here, note that the magnetic flux density and the coercivity are each measured along the x axis while the resistivity is measured along the z axis of FIG. 2.

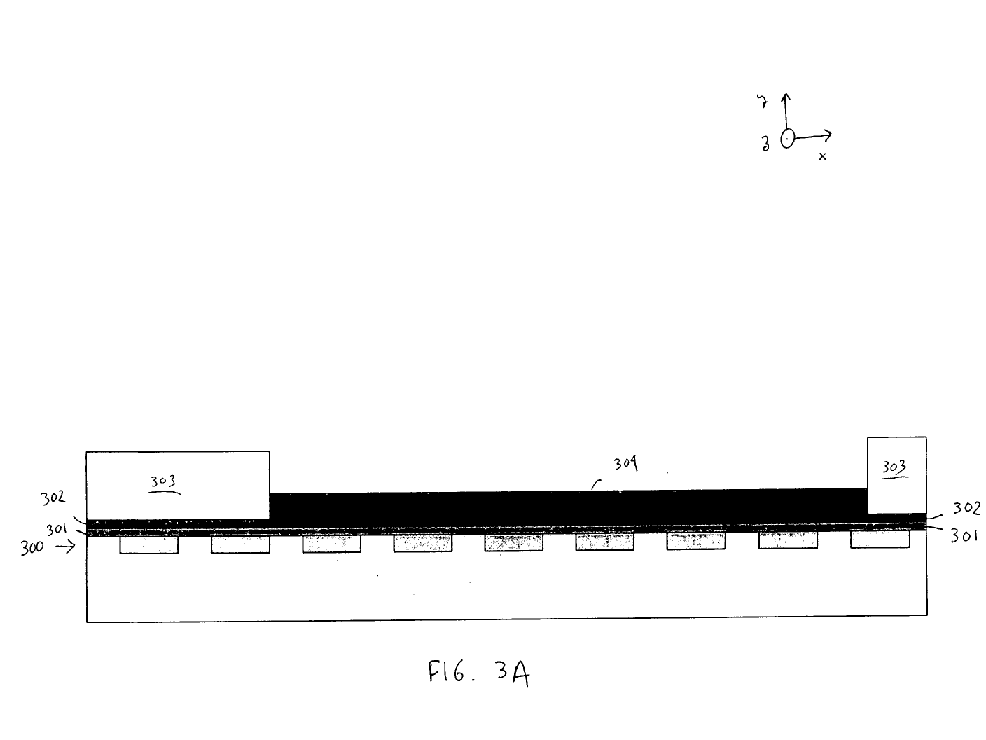

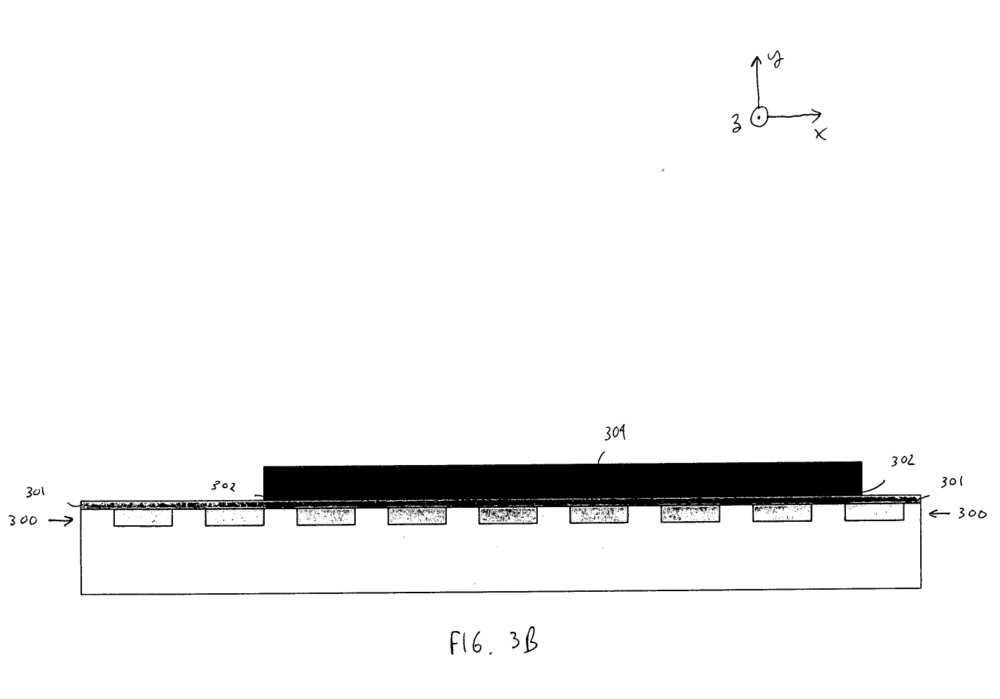

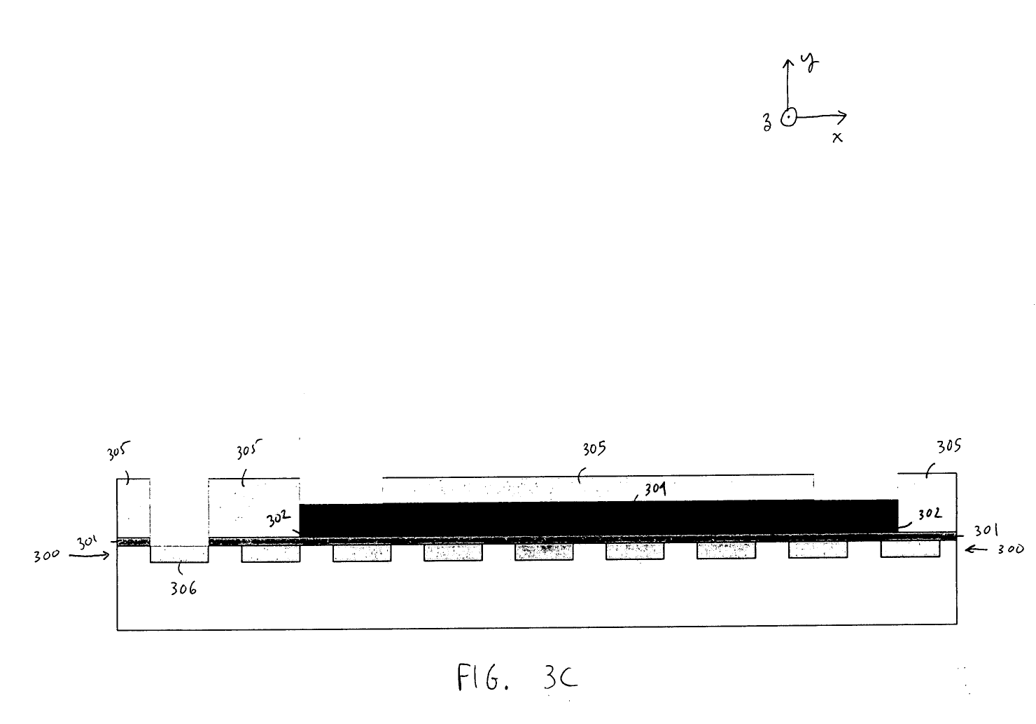

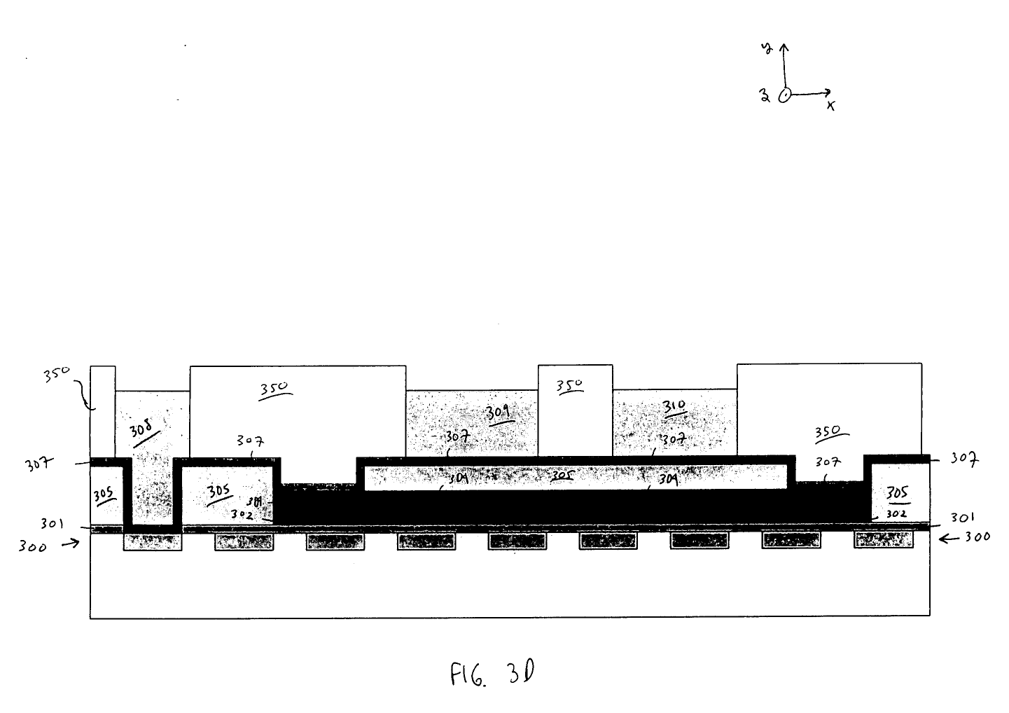

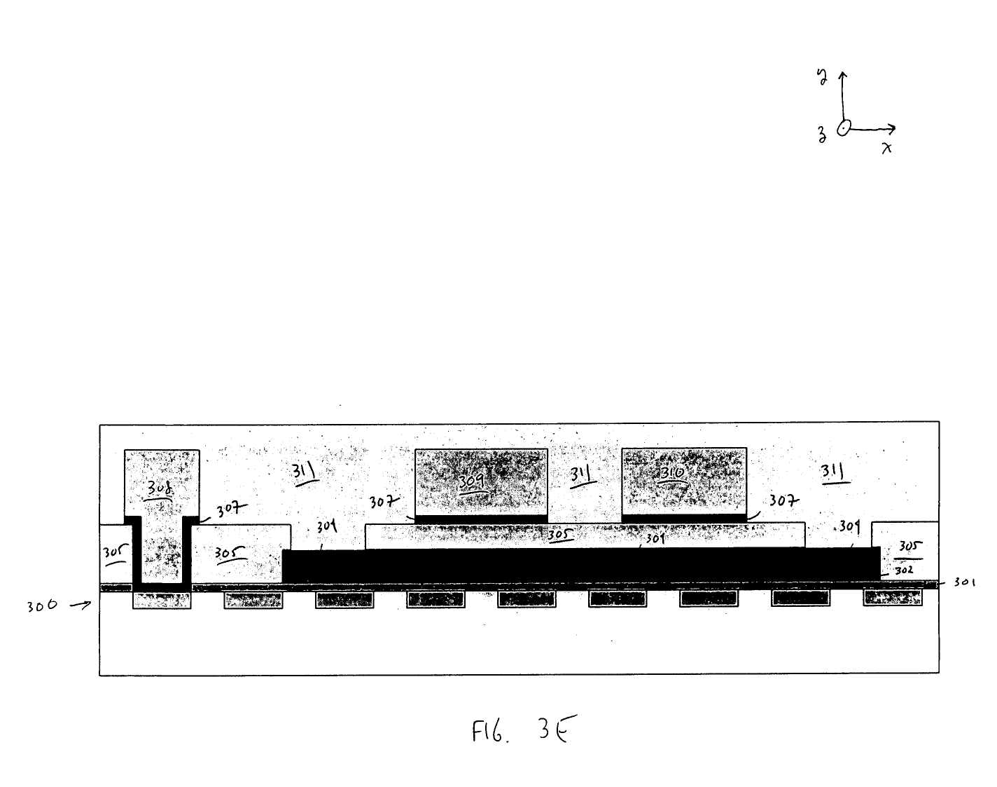

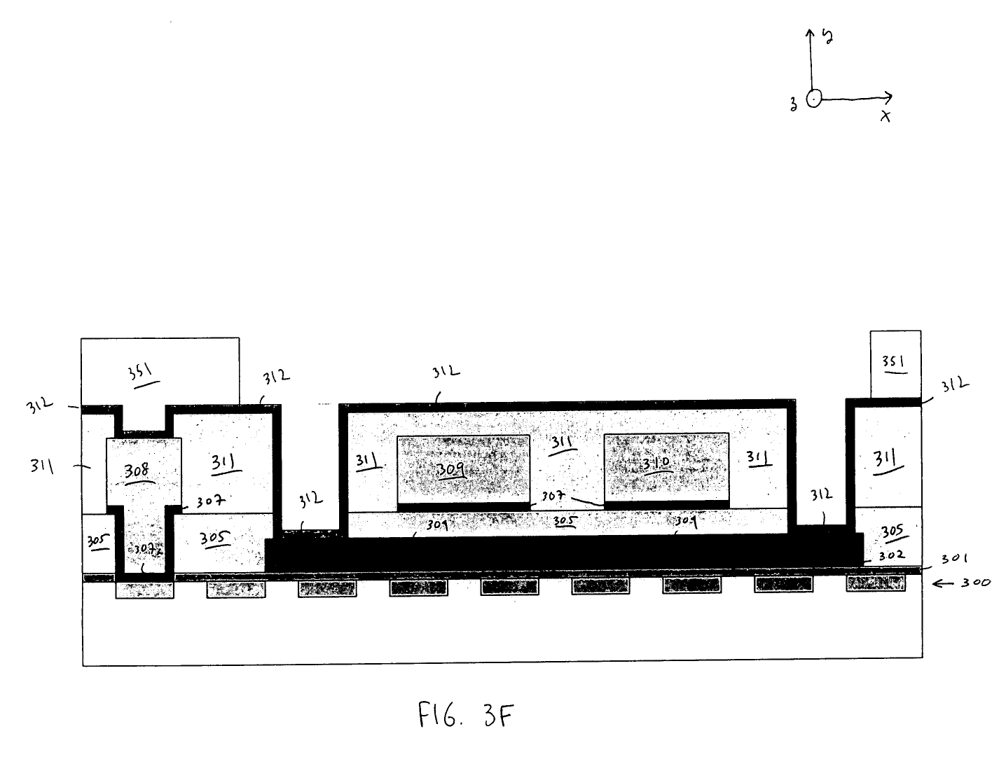

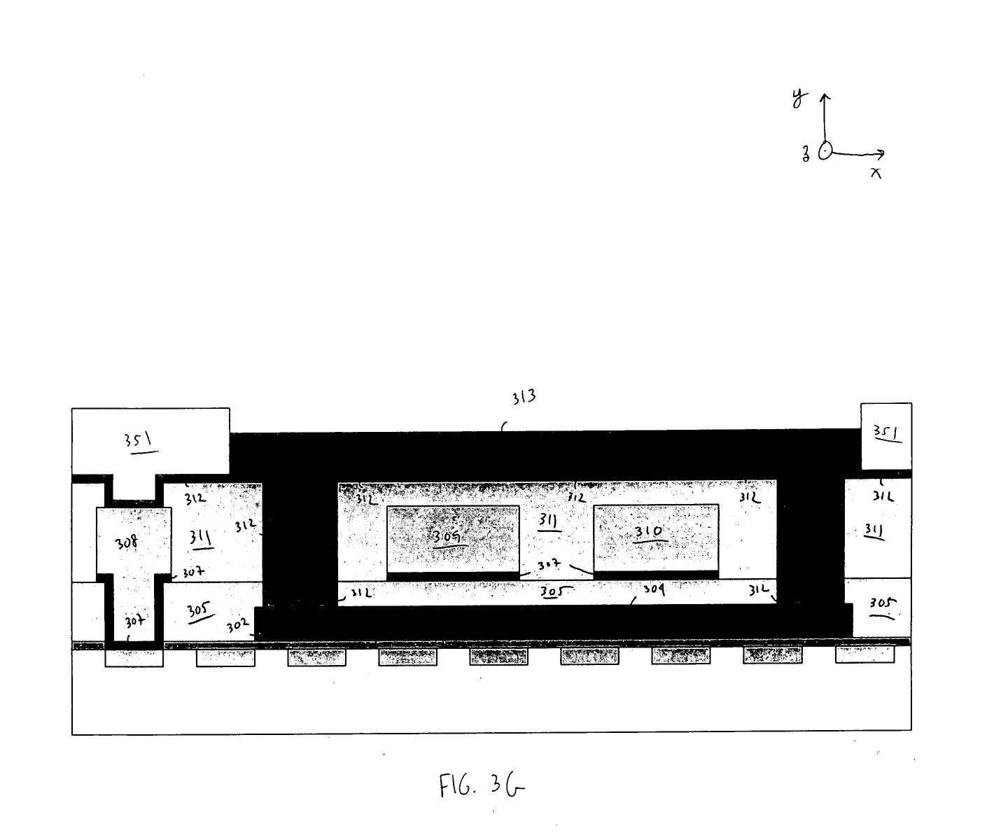

FIGS. 3_A through 3_G show a process flow for forming on die inductively coupled wires as described above including magnetic layering having both sufficiently soft magnetic properties to maintain magnetic coupling efficiency and sufficiently high resistivity to improve power dissipation efficiency. According to FIG. 3_A, a nitride passivation layer 301 (e.g., Si₃N₄) is coated over the highest interconnect metal wiring level 300 that has been formed over the semiconductor die. Then, a seed layer 302 for promoting the deposition of the lower magnetic layer, discussed in more detail below, is deposited by plasma vapor deposition (PVD) over the nitride layer 301. According to one possible approach, the seed layer 302 may be any of Copper (Cu), Cobalt (Co), Platinum (Pt), Palladium (Pd), Nickel (Ni), or an alloy of NiₓFe₁₋ₓ (where x is within a range of 0-1). Ranges of process parameters suitable for depositing the seed layer by PVD include: 1) wafer pressure=3000-6000 mtorr; 2) DC power=4000-40000 Watts; 3) Ar gas flow=2-20 sccm; 4) temperature set point=20-35° C.°.

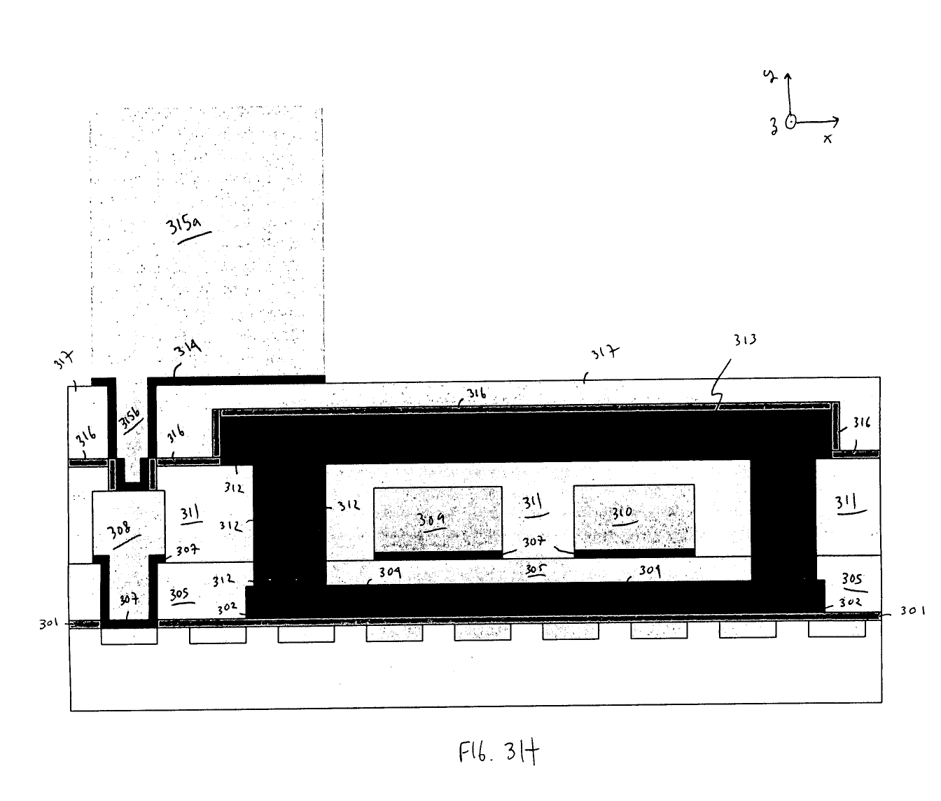

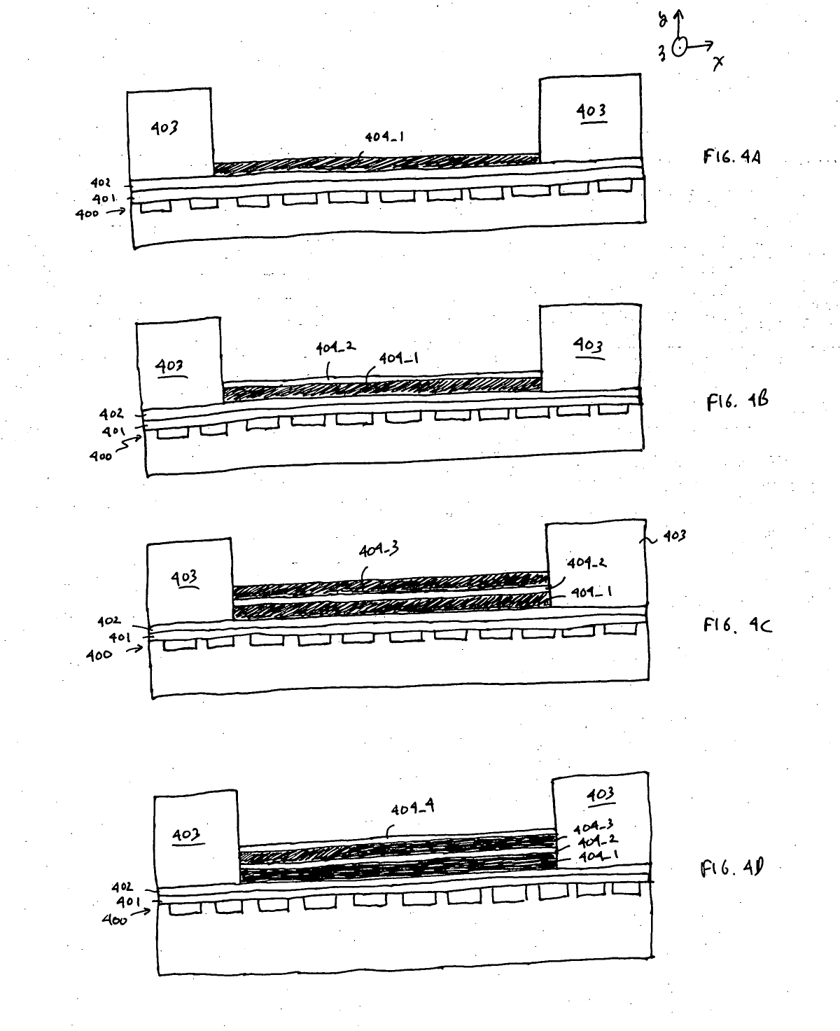

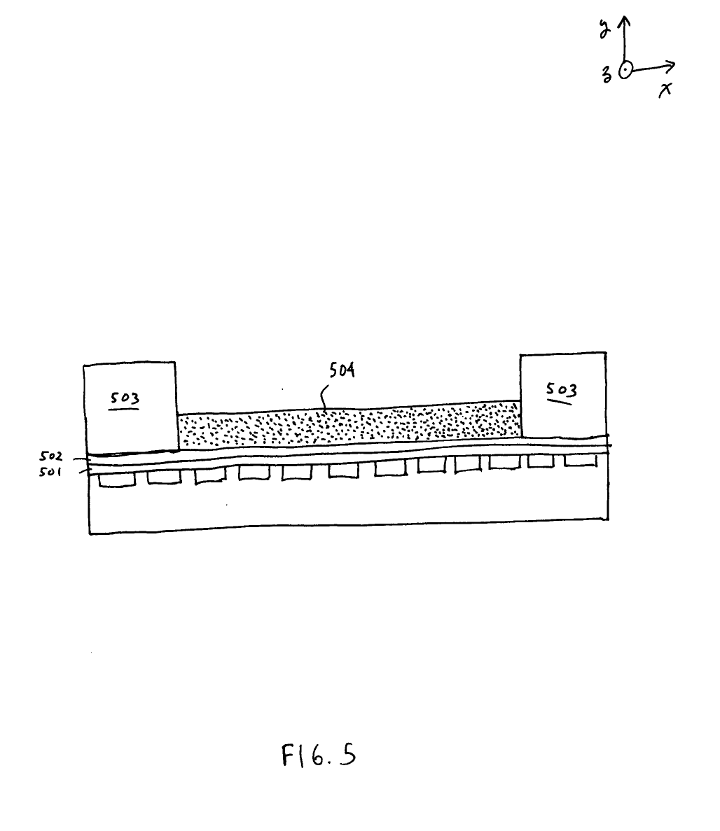

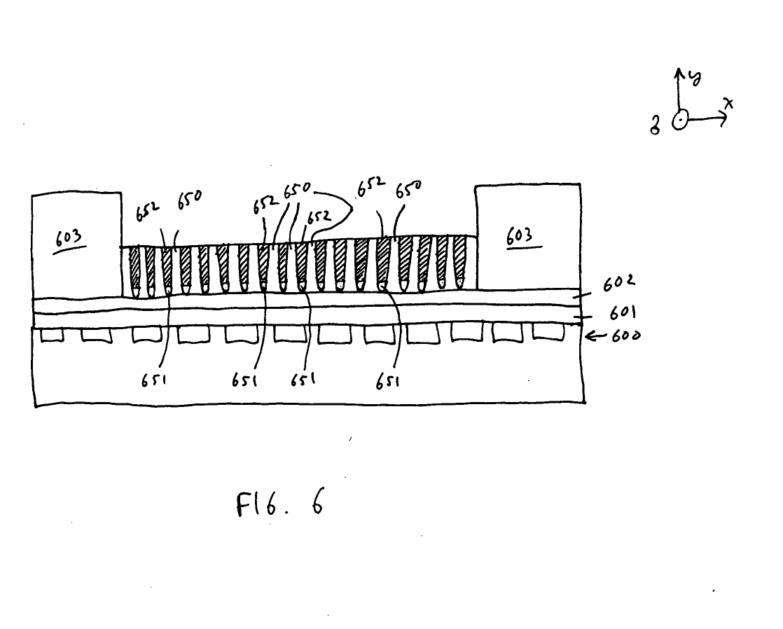

After the seed layer 302 is deposited, a layer of photoresist 303 is coated over the wafer (e.g., by being spun on) and is patterned with photolithography techniques to form an opening where the lower magnetic layer is to be formed. The lower magnetic layer 304 is then formed. Different approaches are herein described for forming lower magnetic layer 304. Specifically, a first approach which forms a laminated-like lower magnetic layer 304 is depicted in FIGS. 4a through 4d, a second approach which embeds soft magnetic nanocomposite materials into a dielectric material is depicted in FIG. 5, and, a third approach which infuses a porous dielectric layer with soft magnetic material is depicted in FIG. 6.

Each of these approaches effectively fabricate a structure that includes both: 1) a soft magnetic material (potentially having a low electrical resistivity) to ensure that the lower magnetic layer 304 has soft magnetic properties; and, 2) regions of high electrical resistivity (e.g., a dielectric) to ensure that the lower magnetic magnetic layer, as a whole, exhibits high electrical resistivity. Each of the three different approaches are discussed in succession immediately below.

### Laminated-Like Soft Magnetic Layer

FIGS. 4a through 4d show fabrication of lower magnetic layer 304 of FIG. 3 by depositing a soft magnetic layer, then ion-implanting the layer, and alternating this process to form a multi-layer structure that includes numerous soft magnetic and ion-implanted layers. For instance, referring to FIG. 4a, a first soft magnetic layer 404_1 is deposited, then, as depicted in FIG. 4b, the soft magnetic layer 404_2 is ion implanted. The process of FIGS. 4a and 4b is then essentially repeated as observed in FIGS. 4c and 4d. Referring to FIG. 4c, a second soft magnetic layer 404_3 is deposited over the first ion-implanted layer 404_2, then, as depicted in FIG. 4d, the second soft magnetic layer 404_3 is ion-implanted to form a second ion-implanted layer 404_4. The process described just above could conceivably be repeated many times over to effect numerous soft magnetic and ion-implanted layers beyond the pairs of such layers observed in FIGS. 4a through 4d.

The theory behind the formation of the multi-layer structure observed in FIGS. 4a through 4d is that the ion-implanted regions have high electrical resistance, and, because the eddy currents will flow along the z axis, any induced eddy currents will be unable to substantially flow within the ion-implanted regions 404_2, 404_4 and will therefore be forced to flow within the soft magnetic material regions 404_1, 404_3. From an electrical engineering perspective, the ion-implanted regions 404_2, 404_4 effectively reduce the cross-sectional area through which the eddy currents may flow thereby increasing the electrical resistance of the lower magnetic layer 304, 404 as a whole.

According to one perspective, the introduction of the ion-implanted dopant atoms into the soft magnetic layers 404_1, 404_3 results in the formation of a dielectric material having sufficiently high resistance that differs from the material of which the soft magnetic layer is composed (as characterized by its atomic composition, atomic locations and crystal lattice phases). The specific material that is formed is apt to be a function of anneal temperature. The appropriate anneal temperature may be defined through rudimentary optimization (e.g., for any type of ion-implant dopant, varying dopant density and anneal temperature across a number of different samples). For example, the reader is referred to Liu et. al., “Effect Of O-Implantation On The Structure And Resistance Of Ge₂Sb₂Te₅ Film”, Applied Surface Science 242 (2005) 62-69 and Sargunas, et. al., “High Resistivity In n-Type InP By He+ Bomardment At 300 and 60 K”, Solid-State Electronics, Vol. 38, Issue 1, January 1995, pp. 75-81. Note however, because the lower magnetic layer 304, 404 is manufactured above the highest level of metal interconnect 300, 400 it is essentially subject to only the lower temperatures typically associated with passivation and I/O interconnect “back-end” processing (e.g., no higher than 400° C.) that are not capable of causing the ion-implanted layer to anneal.

In an embodiment, each of the ion-implanted layers 404_2, 404_4 are formed to a thickness of 100-200 Å (that is, the ion-implantation depth is 100-200 Å) and the soft magnetic layers are formed to a thickness of (i.e., prior to implantation) 5000 Å. Thus, in the finished structure, the ion-implanted layers have a thickness of 100-200 Å and the soft magnetic layers have a thickness of 4800-4900 Å. This corresponds to an ion-implantation thickness-to-soft magnetic layer thickness ratio of 1:24.

Those of ordinary skill will be able to readily achieve a specific ion-implantation region thickness. However, it is expected that to effect thicknesses within a range of 100-200 Å, low to moderate energies (e.g., within a range of 1.1 to 20 keV, inclusive) are apt to be used for implantation of ionized atoms of any of Carbon (C), Oxygen (O), Silicon (Si), Boron (B), Phosphorous (P), Germanium (Ge) or Helium (He). The density of implanted ions may be within a range of 1 E12 to 1E18 cm⁻² depending on the extent of the compositional change within the soft magnetic film. Depending on the extent of surface oxidation on an implanted surface, a thin initiation layer (e.g., a monolayer) of Pd may be applied by wet methods over an ion-implanted layer and prior to the plating of the next, subsequent soft magnetic layer to essentially form a seed layer for the next soft magnetic layer.

In an embodiment, each soft magnetic layer 404_1, 404_3 is a Cobalt (Co) alloy, Nickel (Ni) alloy or a Cobalt-Iron alloy (CoₓFe₁₋ₓ₎formed by electroless plating. Possible examples include CoₓW₁₋ₓ (where x is within a range of 0.80 to 0.95), CoₓW_{y}B_{z} (where percentages of Co and W may respectively vary within ranges of 80-95% and 5-20%), CoₓB₁₋ₓ (where x is within a range of 0.90 to 0.98), CoₓW_{y}P_{z} (where percentages of Co and W may respectively vary within ranges of 80-95% and 5-20%), NiₓB₁₋ₓ, NiₓW_{y}B_{z}(where percentages of Ni, W and B may respectively vary within ranges of 80-95%, 5-20% and 2-10%), CoₓFe_{y}B_{z} (where percentages of Co, Fe and B may respectively vary within ranges of 80-95%, 2-15% and 2-10%) and Co_{w}FeₓW_{y}B_{z} (where percentages of Co, Fe, W and B may respectively vary within ranges of 80-95%, 2-15%, 5-15% and 2-10%). . . .

Electroless plating processes for the above materials are known in the art. Electroless plating is used because it is preferable to avoid the use of an electrical contact seed layer (which is apt to be the case if electroplating where employed instead), and the surface of the implanted plated layer will remain catalytic to further electroless plating. A potential exemplary electroless plating deposition bath for CoWBP is: 1) 0.01-0.05 M of [Co2+]; 2) 0.1-0.5 M of citrate as a complexing agent so Co is not precipitated at high pH levels; 3) 0.001-0.05 M of [WO₄²]; 4) 0.5-1.0 M of [BO₃³]; 5) 0.02-0.1 M of ammonium hypophosphite; 6) 0.02-0.1 M of dimethylamineborane; 7) pH=8.3-9.7; and, 8) temperature=60°-70° C.

### Magnetic Layer with Embedded Soft Magnetic Nanocomposites

FIG. 5 shows an alternate embodiment for forming the lower magnetic layer 304 of FIG. 3 in which “nanocomposites” are combined in a plating bath for depositing a transition metal alloy (e.g., an alloy of Co, Fe or Ni) so that the plating process produces a layer 504 of the transition metal alloy 550 that is populated or embedded with the nanocomposites 551. The nanocomposites are nanoscale dimensioned particles (e.g., approximately 1-100 nm in diameter) having a first inner material or phase of a soft magnetic material (e.g., Co, Fe, NiₓFe_{y}, Ni—Zn ferrite) that is completely surrounded by a second electrically insulating material or phase (e.g., Si0₂). The manufacture of such nanocomposites is already known in the art. For instance, the reader is referred to Y. D. Zhang et. al., IEEE Trans. on Magnetics, 37(4), 2001, 2275-2277 and U.S. Pat. No. 6,720,074 B2.

Here, the introduction of the nanocomposites to the layer 504 increases the electrical resistance of the layer 504 because of their non-conductive exterior. In order to effect a high resistive material, a high concentration of nanocomposites should be deposited so that the overall layer is less of a transition metal alloy layer than it is a tightly packed agglomeration of nanocomposites. Better said, the closer the packing density of the overall layer, the more electrically resistive the layer should be because the dielectric exteriors of the noncomposites will be in greater contact with one another resulting in a more electrically resistive layer, with a minimum of 50% nanocomposite loading required for a 100× increase in overall resistivity. But at the same time, their introduction to the layer 504 does not substantially deplete the soft magnetic properties of the layer because of their soft magnetic inner core. B_{SAT} for layer 504 can be greater than 1 Tesla even where the nanocomposites make up over 80% of the layer 504 by volume.

With respect to the plating process itself, the nanocomposite particles are suspended in an aqueous solution or electroplating bath through the use of appropriate surfactants. The bath may be agitated (e.g., by pumping) in order to maintain suspension of the particles. Seed layer 502 provides either an initiation source for electroless deposition or an electrical contact for electroplating. Preferred materials for seed layer 502 include Cu, Pd, Co or Ni. An example of a plating bath for deposition of a CoWB layer having nanocomposites with a Co core and SiO₂ exterior is as follows: 1) 0.01-0.05M of [Co2+]; 2) 0.1-0.5M of citrate; 3) 0.001-0.05M of [WO₄²]; 4) 0.5-1.0M of [Bo₃³]; 5) 0.02-0.1 M of dimethylamineborane; 6) 50-200 ppm of surfactant; 7) nanocomposites with 30 nm average diameter with solution loading of 0.5-1.0 g/L; 8) pH=8.3-9.7; 9) Temp.=60-80° C.

### Porous Dielectric with Soft Magnetic Material in its Porous Regions

FIG. 6 shows an alternate embodiment for forming the lower magnetic layer 304 of FIG. 3 in which the layer is first formed as a porous dielectric 650. According to one embodiment, the porosity of the dielectric is such that the openings run vertically along the y axis such that, if one looks down in the −y direction onto the surface of the dielectric 650, a dense plurality of cylindrical-like holes is observed running from the top surface of the dielectric 650 toward the seed layer 602. A soft magnetic material 652, which may be electrically conductive, is also deposited to “fill” the vertically oriented pores in the dielectric 650. The resulting structure has high electrical resistance because of the presence of the dielectric that surrounds each “vertical peg” of soft magnetic material that fills a pore, yet, exhibits soft magnetic properties because of the dense presence of soft magnetic material that fills these pores.

In fabricating this structure, first the seed layer 602 is deposited. The seed layer 602 may be formed and be made from the same materials as described above with respect to seed layer 302 of FIG. 3 and provides a fresh metal surface for nucleating the deposition process of the dielectric that follows. Next, the porous dielectric layer 650 is formed. Deposition of porous dielectrics as described just above are known in the art in relation to the fabrication of nanowire arrays. For example, Huang et al., “Observation of Isolated Nanopores Formed by Patterned Anodic Oxidation of Aluminum Thin Films”, Appl. Phys. Lett., 88, 233112, describe a process for the formation of porous alumina from sputtered Al thin films. Therefore, the porous dielectric layer 650 may be formed by first sputtering an adhesion layer such as Ti (with a thickness ranging from 10 to 50 nm), and subsequently sputtering Al to the desired total magnetic layer thickness (1 to 4 microns). Following deposition of the Ti/Al stack, the exposed Al is then anodized, for example by applying a DC voltage of 30-60 V to the substrate while it is immersed in a 0.1-0.4 M aqueous solution of oxalic acid at 5-25 C. The pore diameters are then made larger by immersing the substrate into a dilute phosphoric acid solution (0.1-0.4 M) maintained at 25-50 C. Expansion of the pore diameters to a relatively low aspect ratio of 5 or less will mitigate the tendency of shape anisotropy to align the magnetic moment perpendicular to the film plane.

It is expected that the pores will not be open at the bottom of layer 650 so as to expose the seed layer, therefore requiring a thin catalyst layer 651 to be deposited on the bottoms of the pores that will serve as a seed layer to promote the deposition of the soft magnetic material 652 within the pores themselves. According to one approach, the catalyst layer material includes Pd and is deposited using an approach similar to the described in Severin et al., “A Study on Changes in Surface Chemistry During the Initial Stages of Electroless Ni(P) Deposition on Alumina”, J. Electrochem. Soc., 140(3), 682. Specifically, the substrate is immersed in the following solutions, in order: (a) DI water for 1-5 min at 20-50 C, for cleaning; (b) 0.1-5% HF for 1-5 min at 20-30 C, for etching; (c) 10-100 g/L aqueous SnCl₂ for 1-5 min at 20-30 C, for sensitizing; (d) DI water for 1-5 min at 20-50 C, for rinsing; (e) 0.1-0.5 g/L aqueous PdCl₂ mixed with 1-5 mL/L HCl for 1-5 min at 20-30 C, for activating.

After the catalytic layer is deposited, the remaining empty portions of the pores are substantially filled with soft magnetic material 652 by electroless plating. As discussed above with respect to layers 404_1 and 404_3 of FIG. 4, the soft magnetic material 652 is a Cobalt (Co) alloy, Nickel (Ni) alloy or a Cobalt-Iron alloy (CoₓFe₁₋ₓ). Possible examples include CoₓW₁₋ₓ (where x is within a range of), CoₓW_{y}B_{z} (where percentages of Co and W may respectively vary within ranges of 80-95% and 5-20%), CoₓB₁₋ₓ (where x is within a range of 0.90 to 0.98), CoₓW_{y}P_{z} (where percentages of Co and W may respectively vary within ranges of 80-95% and 5-20%), NiₓB₁₋ₓ, NiₓW_{y}B_{z}(where percentages of Ni, W and B may respectively vary within ranges of 80-95%, 5-20% and 2-10%), CoₓFe_{y}B_{z} (where percentages of Co, Fe and B may respectively vary within ranges of 80-95%, 2-15% and 2-10%) and Co_{w}FeₓW_{y}B_{z} (where percentages of Co, Fe, W and B may respectively vary within ranges of 80-95%, 2-15%, 5-15% and 2-10%).

Electroless plating processes for the above materials are known in the art. Electroless plating is used because it is preferable to avoid the use of an electrical contact seed layer. A potential exemplary electroless plating deposition bath for CoWBP is: 1) 0.01-0.05 M of [Co2+]; 2) 0.1-0.5 M of citrate as a complexing agent so Co is not precipitated at high pH levels; 3) 0.001-0.05 M of [WO₄²]; 4) 0.5-1.0 M of [BO₃³]; 5) 0.02-0.1 M of ammonium hypophosphite; 6) 0.02-0.1 M of dimethylamineborane; 7) pH=8.3-9.7; and, 8) temperature=60°-70°.

### Remainder of Manufacture of Inductively Coupled Wires

Referring back to FIG. 3_B, after the lower magnetic layer 304 is formed, the photoresist layer 303 (see FIG. 3A) and the portion of the seed layer 302 directly beneath the photoresist layer 303 are removed. The photoresist layer 303 may be removed by a wet etch and the seed layer 302 may be removed by a wet etch. Then, as depicted in FIG. 3_C, the lower layer dielectric 305 (e.g., as composed of a nitride such as Si₃N₄) is deposited or spun over the surface of the wafer (e.g., by physical or chemical deposition), photoresist is applied, patterned and etched (not shown) leaving open vias above the lower magnetic layer 304 and any I/O wire (such as I/O wire 306) requiring electrical contact to an I/O (such as a solder ball, C4 joint, etc.).

After etching any nitride layer 301 that resides over an I/O wire 306 to expose the I/O wire 306 (noting that the portions of the nitride layer 301 beneath magnetic layer 304 and lower dielectric layer 305 are not removed by the etch because they are protected by respective layers 304, 305), referring now to FIG. 3D, barrier/seed layer 307 is deposited over the lower dielectric 305 and the exposed areas of the lower magnetic layer 304 and I/O wire 306. According to one implementation, the barrier/seed layer 307 is composed of Cu and Titanium (Ti) and is deposited by physical vapor deposition such as evaporation or sputtering.

Another layer of photoresist 350 is deposited, patterned and etched to create regions where electrically conductive wiring such as contact via 308 and primary and secondary wires 309 and 310, respectively are later deposited. In one embodiment the electrically conductive wiring is composed of Cu. In this case, the barrier/seed layer 307 acts as a barrier layer for the Cu contact via 308 and primary, secondary wiring metal 309, 310. After removing the photoresist 350, the higher layer dielectric 311 is then deposited or spun on over the wafer as depicted in FIG. 3_E.

Another layer of photoresist (not shown) is subsequently applied, patterned and etched to expose openings over any contact vias (such as contact via 308) and over the lower magnetic layer 304 where the interlayer lower and higher magnetic layers are to be connected. As depicted in FIG. 3_F, after removing the photoresist, another seed layer 312 similar to seed layer 302 is then deposited over the wafer. According to one embodiment, seed layer 312 (like seed layer 302) is formed by depositing Cu, Co, Pt, Pd, an Al alloy or an AlₓCu₁₋ₓ alloy. Another layer of photoresist 351 is then applied, patterned and etched to form an opening where the higher magnetic layer 313 is to be deposited.

As depicted in FIG. 3_G, the higher magnetic layer 313 is formed. Like lower magnetic layer 304, higher magnetic layer 313 may be a layer comprising dielectric material and soft magnetic material as discussed above with respect to FIGS. 4a-d, 5 and 6. After removing the resist, seed layer 312 is removed everywhere except beneath the higher magnetic layer 313.

Referring to FIG. 3H, passivation 316 and polymer 317 layers are then successively formed over the wafer. Photoresist is applied, patterned and etched to form openings over the passivation and polymer residing over any contact vias such as contact via 308. The passivation and polymer layers residing over a contact via 308 are then removed and another seed layer 314 (e.g., an alloy of Ti and Cu) is formed over the wafer so as to at least cover the exposed contact via 308. Contacts (e.g., solder bumps, C4 balls, etc.) are then formed over the contact via 308 including a second, stacked via 315b between the actual contact 315a and via 308. The portions of the seed layer 314 that are not protected by contact 316 are then etched away.

It will be evident to one of ordinary skill that the secondary wire 210, 310 of FIGS. 2 and 3H may be routed back around an end of the magnetic core to form a cross section of surface area bounded by the secondary wire that magnetic flux within the magnetic core will flow through. Conceivably, in order to form a transformer, either or both the primary and secondary wires may be looped around the magnetic core as well. In this case, a cross section of the inductively coupled wires might reveal any such looped wire to be stacked within the dielectric that is surrounded by the magnetic core. For instance, if the secondary wire were looped three times around the magnetic wire, three separate secondary wire cross sections might be observed stacked upon each other within dielectric region 305, 311. In this case, the separation of the higher and lower magnetic layers may be increased to account for the stacked wiring within the region bounded by the magnetic core.

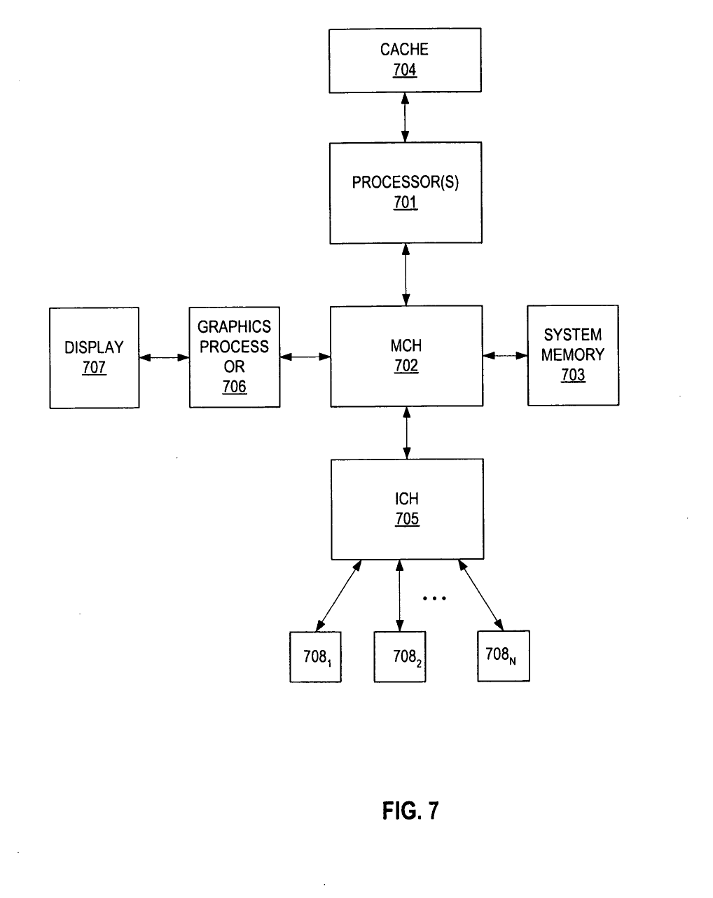

The semiconductor die on which the inductively coupled wires are integrated may be a semiconductor die used to implement a component within a computing system. FIG. 4 shows an embodiment of a computing system (e.g., “a computer”) and some of its various components. The exemplary computing system of FIG. 7 includes: 1) one or more processors 701; 2) a memory control hub (MCH) 702; 3) a system memory 703 (of which different types exist such as DDR RAM, EDO RAM, etc,); 4) a cache 704; 5) an I/O control hub (ICH) 705; 6) a graphics processor 706; 7) a display/screen 707 (of which different types exist such as Cathode Ray Tube (CRT), Thin Film Transistor (TFT), Liquid Crystal Display (LCD), DPL, etc.; 8) one or more I/O devices 708.

The one or more processors 701 execute instructions in order to perform whatever software routines the computing system implements. The instructions frequently involve some sort of operation performed upon data. Both data and instructions are stored in system memory 703 and cache 704. Cache 704 is typically designed to have shorter latency times than system memory 703. For example, cache 704 might be integrated onto the same silicon chip(s) as the processor(s) and/or constructed with faster SRAM cells whilst system memory 703 might be constructed with slower DRAM cells. By tending to store more frequently used instructions and data in the cache 704 as opposed to the system memory 703, the overall performance efficiency of the computing system improves

System memory 703 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 703 prior to their being operated upon by the one or more processor(s) 701 in the implementation of a software program.

Similarly, data that a software program determines should be sent from the computing system to an outside entity through one of the computing system interfaces, or stored into an internal storage element, is often temporarily queued in system memory 703 prior to its being transmitted or stored. The ICH 705 is responsible for ensuring that such data is properly passed between the system memory 703 and its appropriate corresponding computing system interface (and internal storage device if the computing system is so designed).

The MCH 702 is responsible for managing the various contending requests for system memory 703 access amongst the processor(s) 701, interfaces and internal storage elements that may proximately arise in time with respect to one another. One or more I/O devices 708 are also implemented in a typical computing system. I/O devices generally are responsible for transferring data to and/or from the computing system (e.g., a networking adapter); or, for large scale non-volatile storage within the computing system (e.g., hard disk drive). ICH 705 has bi-directional point-to-point links between itself and the observed I/O devices 708.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. On-die inductively coupled wires, comprising:
a) a first wire to carry a first current;
b) a surface area bounded by a second wire; and,
c) a layer to couple magnetic flux induced by said first current through said surface area, said layer comprising regions of dielectric material and regions of soft magnetic material.

2. The on-die inductively coupled wires of claim 1 wherein said layer comprises alternating layers of said dielectric material and said soft magnetic material.

3. The on-die inductively coupled wires of claim 2 wherein said layers of said dielectric material comprises said soft magnetic material and implanted atoms.

4. The on-die inductively coupled wires of claim 3 wherein said soft magnetic material is selected from the group consisting of:
a Co alloy;
a Ni alloy;
a Co—Ni alloy.

5. The on-die inductively coupled wires of claim 1 wherein said layer comprises a layer of material embedded with nanocomposites, said nanocomposites having:
a) an inner core of said soft magnetic material; and,
b) said dielectric material surrounding said inner core.

6. The on-die inductively coupled wires of claim 1 wherein said soft magnetic material is selected from the group consisting of:
Co;
Fe;
NiₓFe_{y};
Ni—Zn ferrite.

7. The on-die inductively coupled wires of claim 1 wherein said layer comprises said dielectric material having pores and said soft magnetic material within said pores.

8. The on-die inductively coupled wires of claim 7 comprising a catalyst layer within said pores between the bottoms of said pores and said soft magnetic material within said pores.

9. A method, comprising:
a) electroless plating a layer of material selected from the group consisting of:
a Co alloy;
a Ni alloy;
a Co—Ni alloy;
b) ion-implanting atoms into a surface of said layer to form a dielectric layer at said layer's surface;
c) electroless plating, over said dielectric layer, a second layer of material selected from the group consisting of:
a Co alloy;
a Ni alloy;
a Co—Ni alloy; and,
d) ion-implanting atoms into a surface of said second layer to form a second dielectric layer at said second layer's surface.

10. The method of claim 9 wherein said layer and second layer are one of:
CoₓW₁₋ₓ
CoₓW_{y}B_{z}
CoₓB₁₋ₓ
CoₓW_{y}P_{z}.

11. The method of claim 9 wherein said layer and second layer are one of:
NiₓB₁₋ₓ
NiₓW_{y}B_{z}.

12. The method of claim 9 wherein said layer and second layer are one of:
CoₓFe_{y}B_{z},
Co_{w}FeₓW_{y}B_{z}.

13. The method of claim 9 wherein said atoms are selected from the group consisting of:
C;
O;
Si;
B;
P;
Ge;
He.

14. The method of claim 9 wherein further comprising, between b) and c) depositing a layer of Pd on said dielectric layer.

15. A method of making on-die inductively coupled wires, comprising;
a) depositing a first layer comprising packed nanocomposites during processing of a semiconductor wafer having electronic circuitry, said nanocomposites having an inner core of soft magnetic material surrounded by a dielectric exterior;
b) depositing conductive material above said first layer to form first and second electrically isolated wires over said first layer; and,
c) depositing a second layer above said first and second wires, said second layer comprising packed nanocomposites, said nanocomposites of said second layer also having an inner core of soft magnetic material surrounded by a dielectric exterior.

16. The method of claim 15 wherein said depositing of said second layer further comprises substantially filling openings in a material, said openings exposing said first layer.

17. The method of claim 16 wherein said material is a dielectric that electrically isolates said first and second wires from said second layer.

18. The method of claim 15 wherein said depositing is performed by plating.

19. The method of claim 18 further comprises, before a), preparing a plating bath comprising nanocomposites that become part of said first layer.

20. The method of claim 18 wherein said plating also deposits a transition metal alloy.

21. A method of making on-die inductively coupled wires, comprising;
a) depositing a porous oxide layer;
b) depositing a soft magnetic material over said porous oxide layer to substantially fill pores of said porous oxide layer;
c) depositing conductive material above said soft magnetic material to form first and second electrically isolated wires;
d) depositing a second porous oxide layer; and,
e) depositing a second soft magnetic material over said second porous oxide layer to substantially fill pores of said porous oxide layer.

22. The method of claim 21 further comprising depositing a catalyst layer within pores of said porous oxide layer between a) and b).

23. The method of claim 22 wherein said depositing of said soft magnetic material is performed with a plating process.

24. The method of claim 22 wherein said catalyst layer is Pd.

25. The method of claim 23 further comprising depositing a second catalyst layer within pores of said second porous oxide layer between d) and e).

26. The method of claim 21 wherein said porous oxide layer is selected from the group consisting of:
CoFe2O4;
anodic aluminum oxide.
